(19) United States
(12) Patent Application Publication
(10) Pub. No.: US 2018/0171920 A1
(43) Pub. Date: Jun. 21, 2018

(54) METHOD FOR MONITORING THE WORKING OPERATION OF A PIEZO INJECTOR

(71) Applicant: CONTINENTAL AUTOMOTIVE GMBH, Hannover (DE)

(72) Inventors: Tany Gargiso, Donaustauf (DE); Michael Kausche, Regensburg (DE); Peter Matthias Ruße, Tegernheim (DE); Robert Hoffmann, Ruhstorf/Rott (DE)

(73) Assignee: CONTINENTAL AUTOMOTIVE GMBH, Hannover (DE)

(21) Appl. No.: 15/737,700

(22) PCT Filed: Jun. 15, 2016
(86) PCT No.: PCT/EP2016/063793

§ 371 Date: Dec. 18, 2017

(30) Foreign Application Priority Data
Jul. 2, 2015 (DE) 10 2015 212 371.5

(51) Int. Cl. F02D 41/20; F02D 41/22

(52) U.S. Cl. CPC F02D 41/2096; F02D 2041/1433; F02D 41/221

(57) ABSTRACT

A piezo-driven fuel injector is modeled by measuring the actuation current and the actuation voltage of the piezo injector, transforming the actuation current and the actuation voltage into the frequency domain, forming a complex conductance from the actuation current transformed into the frequency domain and the actuation voltage transformed into the frequency domain, and determining one or more parameters of the piezo injector from the complex conductance. Once the complex conductance is determined it is used to detect a fault in the piezo injector.

This application claims the benefit of International application No. PCT/EP2016/063793, filed Jun. 15, 2016, which claims priority to German patent application No. 10 2015 212 371.5, filed Jul. 7, 2015, each of which is hereby incorporated by reference.

### BACKGROUND

The invention concerns a method for monitoring the working operation of a piezo injector.

It is already known to actuate the injection valves of a fuel injection system so that said valves are opened and closed again very accurately at specified points in time in order to very accurately inject a specified amount of fuel under pressure into a cylinder of the combustion engine. In this way, and possibly also by means of additional pre-injections and/or post-injections in addition to a main injection within an injection cycle, the efficiency of the combustion engine can be increased and at the same time exhaust and noise emissions can be reduced.

An injection valve, frequently also referred to as an injector, comprises a closure element that can be moved by means of a drive to open and close the injector. In the closed state of the injector, in which no injection is carried out, the closure element is in a closed position in which it closes all injection openings of the injector. By means of the drive, the closure element can be raised starting from the closed position thereof in order in this way to open at least some of the injection openings and to produce the injection.

The closure element frequently comprises a nozzle needle or is designed as such. In the closed position thereof, said nozzle needle typically sits on a so-called needle seat of the injector. The drive of the injector comprises an actuator for moving the closure element, which is typically designed to raise the closure element from the closed position to a raised height depending on a control signal of the closure element, to hold the closure element at said raised height and/or to move the closure element back into the closed position. For example, said actuator can be a piezo element that expands or contracts as a result of electrical charging or discharging processes and produces a lifting or closing movement of the closure element in this way. Such actuators, also referred to as piezo actuators, are especially well-suited to the accurate and delay-free displacement of the closure element. This is especially the case with so-called directly driven piezo injectors, with which a direct and delay-free force transfer between the piezo actuator and the closure element is enabled.

Piezo injectors have a working cycle. Said working cycle must be reproducible and exactly maintained for the entire operating life of a motor vehicle. The related requirements are defined by national legislation and also by the customers of the manufacturer of the injection systems. Applicable standards are for example UN/ECE R83 for Europe and the California Code of Regulations, Title 13, 1968.2 for the Californian market.

Temporary and permanent deviations of the data of the injection system of a motor vehicle from the respective existing requirements must be able to be detected rapidly and reliably. Otherwise, greatly increased harmful emissions can occur. It can also result in the respective motor vehicle stopping with engine damage.

Regardless thereof, during the operation of a motor vehicle there is the requirement for very accurate knowledge about the parameters of said piezo injector for the purpose of actuating a piezo injector. Said parameters are usually in the form of characteristic fields, etc., are stored in a memory of the control unit of the motor vehicle and must be followed very accurately during the operation of the motor vehicle in the presence of different operating conditions.

Previously known methods for the diagnosis of a piezo injector monitor input variables of the respective control unit and data of the controllers that are present. In the case of directly driven piezo injectors, the actuator also operates as a sensor. The opening and closing points in time of the piezo injector are concluded from the measured voltage profile. For their part, the algorithms used in this connection require the knowledge of certain data of the piezo injector. For example, if the capacitance of the piezo injector changes because of a short-circuit occurring in the piezo injector or contacts of the piezo injector become loose, then possibly false closing points in time are detected that are recognized as valid by previously known diagnostic methods.

### SUMMARY

The object of the invention is to indicate a way in which the previously indicated disadvantages can be eliminated.

This object is achieved by a method with the features specified in claim 1. Advantageous designs and developments of the invention are specified in the dependent claims.

The advantages of the invention consist in particular of the fact that the monitoring of the working operation of a piezo injector is improved by the method according to the invention. For example, failures of piezo injectors are detected reliably and rapidly. Furthermore, previously absent parameters of the piezo injector can be determined by the method according to the invention for any working cycle of the piezo injector and can be used for the adjustment or control of stored model parameters of the piezo injector. Further, necessary adjustments of the actuation current and the actuation voltage of the piezo injector can be carried out using the determined parameters.

Further advantageous properties of the invention arise from the following exemplary description using the figures. In the figures

### BRIEF DESCRIPTION OF THE FIGURES

FIG. 1 shows a sketch of a piezo injector,

FIG. 2 shows a block diagram of a model of a piezo injector,

FIG. 3 shows a sketch of the mechanism of FIG. 2 modeled as a spring-mass system,

FIG. 4 shows a block diagram of a model of a piezo injector used with the invention and

FIG. 5 shows a flow chart for describing a method for monitoring the working operation of a piezo injector.

### DETAILED DESCRIPTION

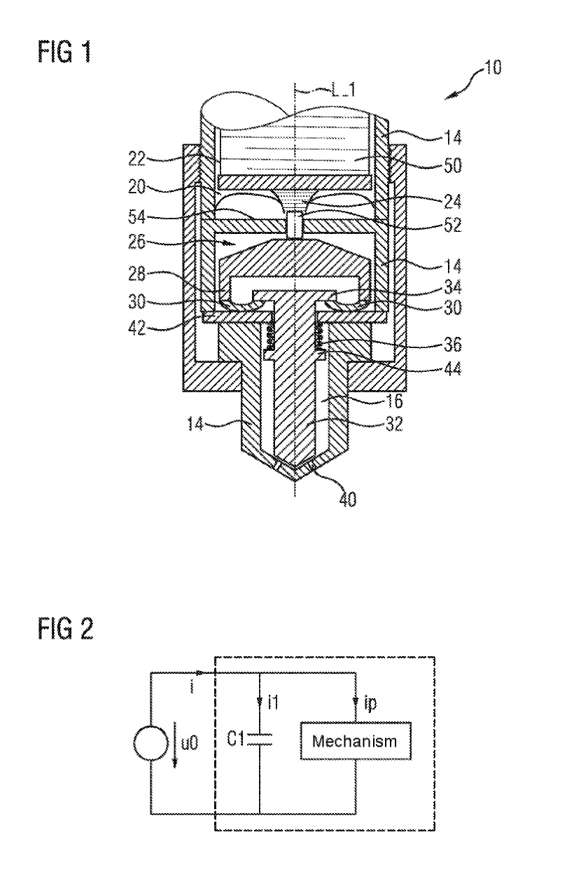

FIG. 1 shows a sketch of a piezo injector of a fuel injection system. The piezo injector 10 that is represented comprises an injector body 14. The injector body 14 is preferably embodied in a multi-part form and comprises a first cavity 16. The first cavity 16 can be coupled to a high-pressure circuit of a fluid that is not shown. It is coupled to the high-pressure circuit when the piezo injector 10 is installed.

The piezo injector 10 comprises a drive mechanism 50 that comprises an actuator 22, a lever mechanism 26, a guide element 54 and a tappet 52.

The actuator 22 is for example disposed in a second cavity 20 of the injector body 14. The actuator 22 is embodied as a lifting actuator and is a piezo actuator that comprises a stack of piezoelectric elements. The piezo actuator changes the axial extent thereof depending on an applied voltage signal.

The actuator 22 comprises a piston 24. The actuator 22 acts via the piston 24 on the lever mechanism 26. The lever mechanism 26 comprises for example a bell-shaped body 28 and lever elements 30. The bell-shaped body 28 and the lever elements 30 are disposed in the first cavity 16. The bell-shaped body 28 is coupled to the lever elements 30. Further, a valve needle 32 is disposed in the first cavity 16. The valve needle 32 comprises a needle head 34. The lever elements 30 act together with the needle head 34 for axial displacement of the valve needle 32.

A nozzle spring 36 is disposed between a support 42 for the injector body 14 and a protrusion 44 of the valve needle 32. The valve needle 32 is biased by means of the nozzle spring 36 so that when in a closed position it prevents a fluid flow through at least one injection opening 40 disposed in the injector body 14 if no further forces are acting on the nozzle needle 32. On actuating the actuator 22, the nozzle needle 32 is displaced from the closed position thereof into an open position, in which it allows the fluid flow through the at least one injection opening 40.

The tappet 52 is disposed between the actuator 22 and the lever mechanism 26 so as to be movable in the axial direction of the longitudinal axis L of the drive mechanism 50. The tappet 52 comprises recesses in a specified sub region of the surface thereof and is coupled in a first contact region to the actuator 22 and in a second contact region to the bell-shaped body 28 of the lever mechanism 26. The tappet 52 preferably comprises a circularly cylindrical cross-sectional area. The tappet 52 can also comprise other suitable forms in further embodiments.

The guide element 54 is disposed between the actuator 22 and the lever mechanism. The guide element 54 is for example part of the injector body 14. The guide element 54 is embodied and disposed so as to guide the tappet 52 axially in the sub region. For this purpose, the guide element 54 comprises a guide borehole, for example.

A block diagram of a simple model of a piezo injector shown in FIG. 1 is shown in FIG. 2. It comprises an electrical capacitance C1 with a mechanism disposed parallel thereto, wherein the current flowing through the capacitance C1 is designated by i1 and the current flowing through the mechanism is designated by ip. The parallel circuit of the capacitance C1 and the mechanism are connected to a voltage source u0 that provides a current i to said parallel circuit.

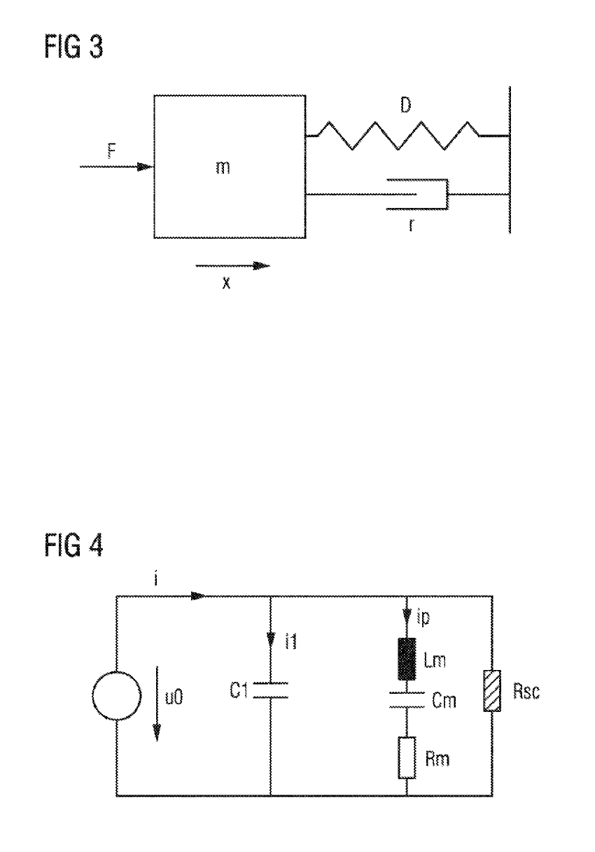

The mechanism represented in FIG. 2 can be modeled in simplified form as a spring-mass system with the mass m, a spring, the friction r, a force F and an elongation x. FIG. 3 shows a sketch of such a spring-mass system.

The following relationship applies:

F=m·d2x/dt2+r·dx/dt+D·x,

wherein

F is the force,

m is the mass,

t is the time,

r is the friction

D is the piezo elasticity and

X is the elongation.

For the mechanical part, an electrical equivalent can be derived.

For the impedance of said mechanical part, the following applies:

Zp(jω)=jω·Lm+1/(jω·Cm)+Rm.

Here Lm is a mechanical inductance, for which the following applies:

Lm=m/(kg·km),

wherein kg is a generator constant and km is a motor constant.

Furthermore, Cm is a mechanical capacitance, for which the following applies:

Cm=kg·km/D.

Further, Rm is a mechanical resistance, for which the following applies:

Rm=r/(kg·km).

FIG. 4 shows a block diagram of a model of a piezo injector used with the invention. In addition to the aforementioned components C1, Lm, Cm and Rm, said model comprises a resistance R_{sc} that is disposed in parallel with the series circuit of Lm, Cm and Rm. Said resistance R_{sc} is a fault resistance. Using the value of said fault resistance, it can be detected whether there is an unwanted electrical short-circuit in the piezo element, such as occurs for example in the event of a broken individual piezo layer.

From the representation according to FIG. 4, the following relationship for the complex conductance can be derived:

$$Y ( j ω ) = \frac{1 - ω C 1 ( ω Lm - \frac{1}{ω Cm} ) + j ω C 1 Rm}{Rm + j ( ω Lm - \frac{1}{ω Cm} )} + \frac{1}{{R}_{SC}} .$$

Using said conductance, the following parameters can be determined:

For the frequency ω=0 the following applies:

$${R}_{SC} = \frac{1}{Y ( j ω )} .$$

For the resonant circuit frequency ω1 of the elements Lm, C1 and Cm for maximum conductance Y the following applies:

ω1=(Cm/Lm)^{1/2}.

For the resonant circuit frequency ω2 of the elements Lm, C1 and Cm for minimum conductance Y the following applies:

ω2=[(1/C1+1/Cm)/Lm]^{1/2}.

Furthermore, a capacitance ratio can be determined as follows:

$$\frac{Cm}{C 1} = {( \frac{ω 2}{ω 1} )}^{2} - 1.$$

For the capacitance Cm, for low frequencies w→0 the following applies:

$$Cm = \frac{Y ( j ω )}{jw ( 1 + \frac{1}{Cm / C 1} )} .$$

For the resistance Rm, the following applies for high frequencies w→∞ for a real conductance if Rsc→∞:

$$Rm \approx \frac{1}{Y ( j ω )} .$$

For the inductance Lm the following applies:

$$Lm = \frac{1}{Cm \cdot {ω}_{1}^{2}} .$$

Investigations carried out on a sample produced the following values:

f1=12 KHz; f2=13 KHz; Cm/C1=017; Cm=7.4 μF;

C1=1.3 μF; Rm=2 Ohm; Lm=24 μH; C_{ges}=8.7 μF; R_{sc}→∞.

Here f1 and f2 are piezo eigenfrequencies.

The aforementioned parameters f1, f2, Cm and Lm can be monitored during the operation the piezo injector and can be used for parameter identification of a piezo model. The resistance R_{sc} is only present in the event of fault.

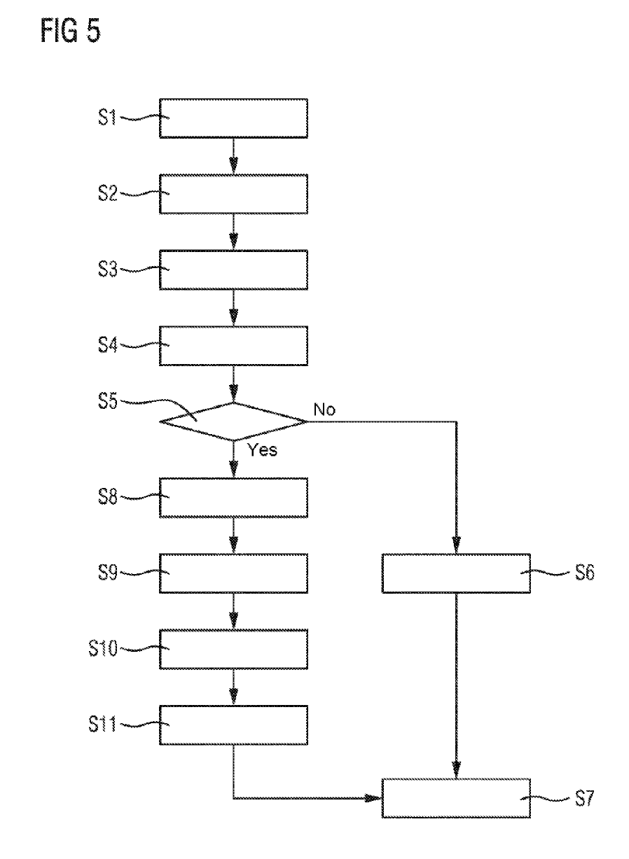

FIG. 5 shows a flow chart for describing a method for monitoring the working operation of a piezo injector using the model described above.

In a step S1, a measurement of the actuation current i(t) and the actuation voltage u(t) of the piezo injector is carried out. Thereafter, in a step S2 a transformation of the actuation current and the actuation voltage into the frequency domain is carried out:

I(jω)=FFT{i(t)}

U(jω)=FFT{u(t)}.

Then in a step S3, formation of the complex conductance from the actuation current transformed into the frequency domain and the actuation voltage transformed into the frequency domain is carried out:

$$Y ( j ω ) = \frac{I ( j ω )}{U ( j ω )} .$$

Then in a step S4, determination of the fault resistance from the complex conductance is carried out:

R_{SC}=Y⁻¹(ω=0).

Then in a step S5, a query as to whether the fault resistance R_{SC} is tending to infinity is carried out:

Rsc→∞?

If this is not the case, then the process moves to a step S6, according to which a fault entry is placed in a fault register. Then the process moves to the step S7, in which for example a fault indication is carried out in a display of the motor vehicle or other measures are initiated.

If on the other hand it is detected in the step S5 that the fault resistance R_{SC} is tending to infinity, then the process moves to step S8. In said step S8, a determination of the aforementioned resonant circuit frequencies ω1 and ω2 is carried out, wherein the first resonant circuit frequency ω1 is determined for a maximum of the complex conductance and the second resonant circuit frequency ω2 is determined for a minimum of the complex conductance.

Then in a step S9, determination of the ratio of capacitances Cm/C1 and determination of the electrical capacitance C1 and the mechanical capacitance Cm is carried out.

During this, first the determination of the ratio of capacitances is carried out by spectral analysis. The mechanical capacitance Cm is determined by considering the limiting case w→0. From the frequency ratio and the mechanical capacitance Cm, C1 is calculated by means of

$$\frac{Cm}{C 1} = {( \frac{ω2}{ω1} )}^{2} - 1.$$

In this case, for low frequencies w→0 the following applies:

$$Cm \approx \frac{Y ( j ω )}{j ω ( 1 + \frac{1}{( \frac{Cm}{C 1} )} )} .$$

Then determination of the mechanical resistance Rm is carried out in a step S10. For high frequencies w→∞ and for real conductance, if Rsc→∞ the following applies:

$${R}_{m} \approx \frac{1}{Y ( j ω )} .$$

Finally, in a step S11 a determination of the mechanical inductance Lm is carried out as follows:

$$Lm = \frac{1}{Cm \cdot ω {1}^{2}} .$$

Then the process moves to the step S7, in which one or more of the aforementioned parameters are used for detection of faulty behavior and possibly also for correction of said faulty behavior of the piezo injector.

For example, conclusions are drawn regarding the presence of a faulty piezo injector from the determined fault resistance—as already mentioned above—and a corresponding indication is initiated. Furthermore, the determined parameters can be used for adjusting a stored characteristic field, the data of which correspond to a model representation of the piezo injector. Further, the determined parameters can also be further processed in an engine control unit, for example for adjustment of the actuation current, the actuation voltage and/or the actuation period of the piezo injector. The robustness of the fuel injection system is increased in an advantageous manner by the described determination of the parameters and the further processing thereof in the engine control unit.

A method according to the present invention enables the detection of the ageing process of a piezo injector and enables the timely and reliable detection of the violation of specified system tolerances.

Further, the method described above provides the fault resistance R_{SC}, the mechanical capacitance Cm, the electrical capacitance C1, the mechanical inductance Lm and the mechanical resistance Rm as variables. Each of said individual variables can be used for diagnostic purposes.

1. A method for monitoring the working operation of a piezo injector with the following steps:
measurement of the actuation current and the actuation voltage of the piezo injector,
transformation of the actuation current and the actuation voltage into the frequency domain,
formation of a complex conductance [Y(jω)] from the actuation current transformed into the frequency domain and the actuation voltage transformed into the frequency domain,
determination of one or more parameters of the piezo injector from the complex conductance,
using the one or more parameters for the detection of faulty behavior of the piezo injector.

2. The method as claimed in claim 1, characterized in that a fault resistance (R_{sc}) is determined from the complex conductance.

3. The method as claimed in claim 1 or 2, characterized in that a resonant circuit frequency is determined from the complex conductance.

4. The method as claimed in claim 3, characterized in that a first resonant circuit frequency (ω1) is determined for a maximum of the complex conductance.

5. The method as claimed in claim 3 or 4, characterized in that a second resonant circuit frequency (ω2) is determined for a minimum of the complex conductance.

6. The method as claimed in claim 5, characterized in that the first and the second resonant circuit frequencies are used for determination of a ratio of capacitances (Cm/C1).

7. The method as claimed in claim 6, characterized in that a mechanical capacitance (Cm) is determined from the complex conductance and the capacitance ratio.

8. The method as claimed in claim 7, characterized in that a mechanical inductance (Lm) is determined from the mechanical capacitance and the first resonant circuit frequency (ω1).

9. The method as claimed in any one of the preceding claims, characterized in that a mechanical resistance (Rm) is determined from the complex conductance.

10. The method as claimed in any one of claims 2 through 9, characterized in that conclusions regarding the presence of a faulty piezo injector are drawn from the determined fault resistance.

11. The method as claimed in any one of the preceding claims, characterized in that the determined parameters are used for adjusting the stored characteristic field, the data of which correspond to a model representation of the piezo injector.

12. The method as claimed in any one of the preceding claims, characterized in that the determined parameters are processed further in an engine control unit.

13. The method as claimed in claim 12, characterized in that the determined parameters are used for adjustment of the actuation current, the actuation voltage and/or the actuation period of the piezo injector.
